(19) United States
(12) Patent Application Publication
(10) Pub. No.: US 2026/0237121 A1
(43) Pub. Date: Aug. 13, 2026

(54) METHOD FOR VISUALIZING STORY AND APPARATUS THEREOF

(71) Applicant: NAVER WEBTOON Ltd., Seongnam-si (KR)

(72) Inventors: Seung Kwon KIM, Seongnam-si (KR); Gyutae PARK, Seongnam-si (KR); Sangyeon KIM, Seongnam-si (KR); Seung-Hun NAM, Seongnam-si (KR)

(73) Assignee: NAVER WEBTOON Ltd., Seongnam-si (KR)

(21) Appl. No.: 19/205,266

(22) Filed: May 12, 2025

(30) Foreign Application Priority Data
Feb. 13, 2025 (KR) 10-2025-0018401

(51) Int. Cl. G06T 11/60; G06F 40/30; G06T 5/50

(52) U.S. Cl. CPC G06T 11/60; G06F 40/30; G06T 5/50; G06T 2207/20221

(57) ABSTRACT

A method for visualizing a story, and a device thereof may be provided. The method includes obtaining a story, extracting scene description information and character description information by analyzing the story, generating prompts for each of main scenes of the story based on the extracted scene description information and the character description information, generating a background image and foreground images based on the prompts for each of the main scenes of the story, and generating story images for the main scenes of the story by integrating the background image and the foreground images.

### CROSS REFERENCE TO RELATED APPLICATION

The present application claims priority to Korean Patent Application No. 10-2025-0018401, filed Feb. 13, 2025, the entire contents of which are incorporated herein for all purposes by this reference.

### BACKGROUND

### Field

The present disclosure relates to story visualization technologies and, more particularly, to methods for visualizing a story as an image by using a generative artificial intelligence model, and devices thereof.

### Description of the Related Art

A webtoon is visual content based on storytelling. Webtoon artists write storyboards in order to create their works, and then draw and color each frame of stories based on the storyboards. Such a creative process is conducted manually within a limited time (e.g., a deadline), thereby needing a lot of effort from the webtoon artists. Accordingly, various artificial intelligence (AI) technologies are being proposed in order to assist webtoon artists in their creative activities. Among these technologies, interest in story visualization technology using generative artificial intelligence (AI) models is growing significantly. The story visualization technology is a technology that visualizes stories as images by utilizing generative AI models such as a Generative Adversarial Network (GAN) model, a Variational AutoEncoder (VAE) model, or a Diffusion model.

However, conventional story visualization technology has a problem in that images generated through generative AI models may not preserve a narrative structure (e.g., a three-act structure) of a story. In addition, there is a problem in that the conventional story visualization technology lacks semantic association and contextual consistency between the story and the generated images, and/or also it is difficult to systematically extract character attributes and/or a narrative flow from the corresponding story. Therefore, story visualization methods capable of solve at least some of the conventional problems are desired.

### SUMMARY

Some example embodiments of the present disclosure solve the above-described problems and/or other problems. Some example embodiments of the present disclosure provide methods and devices configured to extract scene description information and/or character description information by analyzing a narrative structure and characters of a story, and generate prompts desired for image generation on the basis of the extracted scene description information and/or character description information.

Some example embodiments of the present disclosure provide methods and devices configured to generate each of a background image and foreground images on the basis of prompts for each main scene of a story, and generate images preserving a narrative structure of the corresponding story by integrating the generated background image and foreground images in a desired manner.

Some example embodiments of the present disclosure provide methods and devices configured to generate a background image and foreground images on the basis of prompts for each main scene of a story, and generate images having relatively high semantic consistency and/or contextual consistency with the corresponding story by integrating the generated background image and foreground images in an optimal or desired manner.

According to an example embodiment of the present disclosure, a story visualization method may include obtaining a story; extracting scene description information and character description information by analyzing the story, generating prompts for each of the main scene of the story based on the scene description information and the character description information, generating a background image and foreground images based on the prompts for each of the main scenes of the story, and generating story images for the main scenes of the story by integrating the background image and the foreground images.

According to an example embodiment of the present disclosure, a story visualization server may include one or more processors configured to execute a plurality of instructions cause the story visualization server to perform a plurality of operations, and one or more memories configured to store the plurality of instructions, wherein the plurality of operations includes, obtaining a story, extracting scene description information and character description information by analyzing the story, generating prompts for each of main scenes of the story based on the scene description information and the character description information, generating a background image and foreground images based on the prompts for each of the main scenes of the story, and generating story images for the main scenes of the story by integrating the background image and the foreground images.

According to an example embodiment of the present disclosure, a non-transitory computer-readable storage medium storing instructions thereon, which when executed by at least one processor, may cause a computer system to implement a story visualization method. The method may include obtaining a story, extracting scene description information and character description information by analyzing the story, generating prompts for each of main scenes of the story based on the scene description information and the character description information, generating a background image and foreground images based on the prompts for each of the main scenes of the story, and generating story images for the main scenes of the story by integrating the background image and the foreground images.

In addition, the above-described example embodiments do not enumerate all the features of the present disclosure. The various features of the present disclosure and the strong points and effectiveness thereof may be understood in more detail with reference to the specific example embodiment below.

### BRIEF DESCRIPTION OF THE DRAWINGS

FIG. 1 is a view illustrating a configuration of a story visualization system according to an example embodiment of the present disclosure.

FIG. 2 is a block diagram of a story visualization server according to an example embodiment of the present disclosure.

FIG. 3 is a view illustrating scene-specific prompts generated through a story module according to an example embodiment of the present disclosure.

FIGS. 4A to 4E is a view illustrating a plurality of scene images generated through an image module according to an example embodiment of the present disclosure.

FIGS. 5A and 5B are views illustrating operations of a scene extraction unit according to an example embodiment of the present disclosure.

FIGS. 6A and 6B are views illustrating operations of a character extraction unit according to an example embodiment of the present disclosure.

FIGS. 7A and 7B are views illustrating operations of a prompt generation unit according to an example embodiment of the present disclosure.

FIGS. 8A and 8B are views illustrating operations of a prompt evaluation unit according to an example embodiment of the present disclosure.

FIGS. 9A and 9B are views illustrating operations of a scene element generation unit according to an example embodiment of the present disclosure.

FIGS. 10A and 10B are views illustrating operations of a location extraction unit according to an example embodiment of the present disclosure.

FIGS. 11A to 11C are views illustrating operations of a scene element integration unit according to an example embodiment of the present disclosure.

FIG. 12 is a flowchart illustrating a story visualization method according to an example embodiment of the present disclosure.

FIG. 13 is a block diagram illustrating a computing device according to an example embodiment of the present disclosure.

### DETAILED DESCRIPTION

Hereinafter, example embodiments disclosed in the present specification will be described in detail with reference to the accompanying drawings, but regardless of the reference numerals, the same or similar components are given the same reference numbers, and the overlapping description thereof will be omitted. The words “module” and “part/unit” used as compound words for the components used in the following descriptions are given or mixed in consideration of only the ease of writing the specification, and the words do not have distinct meanings or roles by themselves. That is, the term “part or unit” used in the present disclosure means a software or hardware component such as FPGA or ASIC, and the term “part or unit” performs certain functions. However, “part or unit” is not limited to software or hardware in its meanings. The term “part or unit” may also be configured to reside in an addressable storage medium, or may also be configured to operate one or more processors. Accordingly, as an example, the term “part or unit” includes components such as software components, object-oriented software components, class components, or task components, and other components such as processes, functions, attributes, procedures, subroutines, segments of program codes, drivers, firmware, microcode, circuits, data, databases, data structures, tables, arrays, or variables. The components and functions provided within “parts or units” may be combined into a smaller number of components and “parts or units”, or further separated into additional components and “parts or units”.

In addition, in describing the example embodiment disclosed in the present specification, when it is determined that a detailed description of a related known technology may obscure the subject matter of the example embodiment disclosed in the present specification, the detailed description thereof will be omitted. In addition, the accompanying drawings are only for easy understanding of the example embodiment disclosed in the present specification, and the technical idea disclosed in the present specification is not limited by the accompanying drawings, and thus it should be understood that the accompanying drawings include all changes, equivalents, or substitutes, which are included in the spirit and technical scope of the present disclosure.

As used herein, expressions such as “one of,” “one or more of,” “any one of,” and “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

The present disclosure proposes methods and devices configured to extract scene description information and/or character description information by analyzing a narrative structure and characters of a story, and generate prompts desired for image generation on the basis of the extracted scene description information and/or character description information. In addition, the present disclosure proposes methods and devices configured to generate each of a background image and foreground images on the basis of prompts for each main scene of a story, and generate images preserving a narrative structure of the corresponding story by integrating the generated background image and foreground images in an optimal or desired manner. In addition, the present disclosure proposes methods and devices configured to generate a background image and foreground images on the basis of prompts for each main scene of a story, and generate images having relatively high semantic consistency and/or contextual consistency with the corresponding story by integrating the generated background image and foreground images in an optimal or desired manner. The example embodiments of present disclosure are applicable to any content that has stories such as webtoons, web fairy tales, web novels, games, movies, dramas, animations, etc.

Hereinafter, various example embodiments of the present disclosure will be described in detail with reference to the drawings.

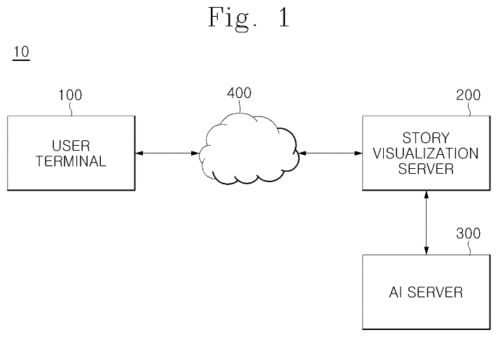

FIG. 1 is a view illustrating a configuration of a story visualization system according to an example embodiment of the present disclosure.

Referring to FIG. 1, the story visualization system 10 according to the example embodiment of the present disclosure may include a user terminal 100, a story visualization server 200, an artificial intelligence (AI) server 300, and a communication network 400. The story visualization server 200 may be referred to as a story visualization device.

The user terminal 100 and the story visualization server 200 may be connected to each other through the communication network 400. The communication network 400 may include a wired network and a wireless network, and specifically, may include various networks such as a local area network (LAN), a metropolitan area network (MAN), and a wide area network (WAN). In addition, the communication network 400 may also include the well-known World Wide Web (WWW). However, the communication network 400 according to the present disclosure is not limited to the networks listed above, and may include at least one of a known wireless data network, a known telephone network, or a known wired/wireless television network.

The user terminal 100 may provide a service for visualizing a story as an image (hereinafter referred to as a “story visualization service”) in conjunction with the story visualization server 200. In this case, the user terminal 100 may display a user interface (UI) for providing the story visualization service on a display unit.

The user terminal 100 may provide a story that is a target of visualization (hereinafter referred to as a “target story”) to the story visualization server 200 according to a user instruction, etc. In this case, the story may be composed of text data or voice data, but is not necessarily limited thereto. Hereinafter, in the present example embodiment, descriptions are provided based on an example in which this story is composed of the text data.

The user terminal 100 may receive, from the story visualization server 200, an intermediate result generated in the process of visualizing a story as an image. The user terminal 100 may display the intermediate result received from the story visualization server 200 on a user interface (UI). A user may review the intermediate result displayed on the user interface (UI) and modify the intermediate result according to his or her review result. In a case where the user modifies the intermediate result, the user terminal 100 may transmit user feedback information about the intermediate result to the story visualization server 200. The story visualization server 200 may update the intermediate result on the basis of the received user feedback information.

The user terminal 100 described in the present specification may include a desktop computer, a laptop computer, a slate PC, a tablet PC, an ultrabook, a mobile phone, a smartphone, a wearable device, etc., but is not necessarily limited thereto.

The story visualization server 200 may provide the story visualization service to the user terminal 100 in conjunction with the AI server 300. The story visualization server 200 may be a web server or a web application server, but is not necessarily limited thereto.

The story visualization server 200 may extract scene description information and/or character description information by analyzing the story received from the user terminal 100, and generate prompts desired for image generation on the basis of the extracted scene description information and/or character description information. In this case, the story visualization server 200 may extract main scenes by analyzing a narrative structure and characters of the story, and generate the prompts for each extracted main scene. The prompts may include a background prompt and foreground prompts.

The story visualization server 200 may generate each of a background image and foreground images on the basis of the prompts for each main scene of the story, and generate a plurality of scene (story) images by integrating the generated background image and foreground images in an optimal or desired manner. In this case, the scene images may be generated so as to secure relatively high semantic consistency and/or contextual consistency with the corresponding story while preserving the narrative structure of the story.

The story visualization server 200 may store the plurality of generated scene images in a storage. In addition, the story visualization server 200 may provide the plurality of generated scene images to the user terminal 100.

The AI server 300 may create a plurality of generative AI models. In this case, the plurality of generative AI models may include a text generation model and/or an image generation model. A Large Language Model (LLM) model such as Chat-GPT or Large Language Model Meta AI (LLAMA) may be used as the text generation model. In addition, a Generative Adversarial Network (GAN) model, a Variational AutoEncoder (VAE) model, or a Diffusion Model (DM) may be used as the image generation model. For example, the Diffusion Model may be used as the image generation model.

The AI server 300 may use the plurality of generative AI models and generate text data and/or image data on the basis of the prompts received from the story visualization server 200. The AI server 300 may provide the generated text data and/or image data to the story visualization server 200.

The present example embodiment illustrates that the AI server 300 providing the plurality of generative AI models is independently built outside of the story visualization server 200, but example embodiments are not necessarily limited thereto. Accordingly, it will be self-evident to those skilled in the art that the AI server 300 may be built within the story visualization server 200.

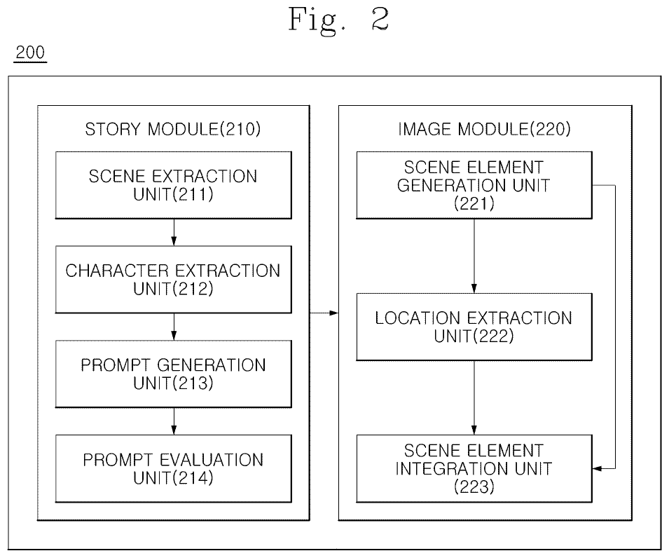

FIG. 2 is a block diagram of a story visualization server according to an example embodiment of the present disclosure.

Referring to FIG. 2, the story visualization server 200 according to the example embodiment of the present disclosure may include a story module 210 and an image module 220. The story module 210 may include a scene extraction unit 211, a character extraction unit 212, a prompt generation unit 213, and a prompt evaluation unit 214. The image module 220 may include a scene element generation unit 221, a location extraction unit 222, and a scene element integration unit 223. According to some example embodiments, the story visualization server 200 may have more or fewer components than the components illustrated in FIG. 2.

The story module 210 may extract scene description information and character description information by analyzing main scenes and characters of the target story, and may generate prompts desired for image generation on the basis of the extracted scene description information and character description information. The story module 210 may provide the generated prompts to the image module 220.

For example, the scene extraction unit 211 may classify a narrative structure of the target story by using the text generation model, and extract the scene description information by identifying the main scenes for each classified act of the narrative structure. Here, the scene description information may include information about backgrounds, foregrounds, and interactions, which are included in the main scenes of the target story. In addition, as the narrative structure of the story, a three-act structure, a five-act structure, or the like may be used, but is not necessarily limited thereto.

The scene extraction unit 211 may provide the extracted scene description information to the user terminal 100. This is for allowing a user to review the scene description information and modify any errors therein. The scene extraction unit 211 may update the scene description information on the basis of user feedback information received from the user terminal 100. The scene extraction unit 211 may provide the updated scene description information to the prompt generation unit 213.

The character extraction unit 212 may analyze key characters appearing in the target story by using the text generation model, and may extract the character description information based thereon. Here, the character description information may include information about feature (attribute) information and relationship information of the characters included in the main scenes of the target story. The feature information of each character may be defined by using desired (or alternatively, predefined) categories (e.g., gender, clothing, movement, location, and/or the like).

The character extraction unit 212 may provide the extracted character description information to the user terminal 100. This is for allowing the user to review the character description information and correct any errors therein. The character extraction unit 212 may update the character description information on the basis of user feedback information received from the user terminal 100. The character extraction unit 212 may provide the updated character description information to the prompt generation unit 213.

The prompt generation unit 213 may combine the scene description information and the character description information and generate prompts desired for image generation on the basis of the combined or integrated description information. In this case, the prompt generation unit 213 may generate the prompts for each main scene of the story by using the text generation model. The prompts may be generated in a form adapted or optimized for input of a diffusion model.

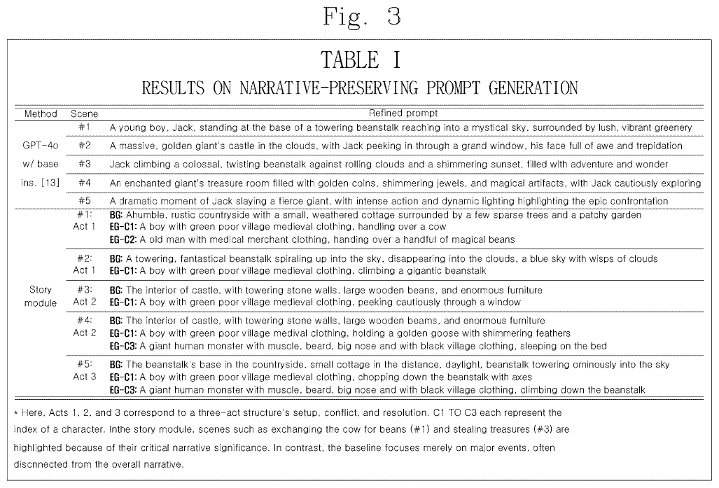

For example, as illustrated in FIG. 3, the prompt generation unit 213 may generate prompts for each scene and each part of the narrative structure (e.g., each act) of the story by using an LLM model. Each prompt may include one background prompt and one or more foreground prompts. A foreground prompt may be generated for each character included in a corresponding scene. For example, in a case where the number of characters included in a particular scene is N, the number N of foreground prompts may be generated.

The prompt generation unit 213 may provide the prompts for each main scene of the target story to the prompt evaluation unit 214.

The prompt evaluation unit 214 may calculate evaluation scores of the prompts for each main scene of the target story by using the text generation model. In this case, the prompt evaluation unit 214 may calculate the evaluation scores by measuring degrees of similarity between the prompts for each main scene of the story and original text of the corresponding story.

The prompt evaluation unit 214 may provide information about the calculated evaluation scores to the user terminal 100.

The image module 220 may generate each of a background image and foreground images for each scene on the basis of the prompts for each main scene of the target story, and may generate a plurality of scene images by integrating the generated background image and foreground images in an optimal or desired manner.

For example, the scene element generation unit 221 may obtain the prompts for each main scene of the target story from the story module 210. The scene element generation unit 221 may generate one background image on the basis of one background prompt by using the image generation model. In addition, the scene element generation unit 221 may generate one or more foreground images on the basis of one or more foreground prompts by using the image generation model.

The scene element generation unit 221 may provide the background image and the foreground images for each main scene of the target story to the location extraction unit 222 and the scene element integration unit 223.

The location extraction unit 222 may extract location information of a character included in each scene on the basis of a background image and global prompts by using the text generation model. Here, the global prompts may include one background prompt and one or more foreground prompts.

The location extraction unit 222 may provide character location information for the main scenes of the target story to the scene element integration unit 223.

The scene element integration unit 223 may generate a stitched image by combining a background image and foreground images on the basis of the character location information. The scene element integration unit 223 may generate a final scene image by inputting the generated stitched image into the image generation model.

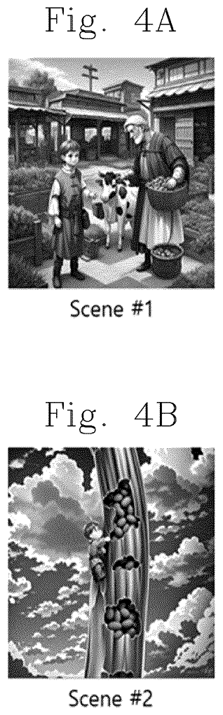

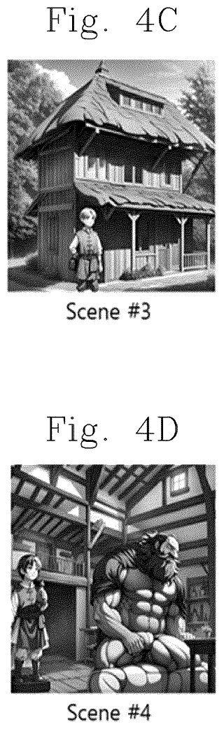

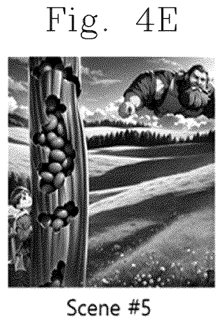

For example, as illustrated in FIGS. 4A to 4E, the scene element integration unit 223 may generate relatively high-quality scene images by using a diffusion model. The diffusion model may generate the scene images having relatively high semantic consistency and/or contextual consistency with the corresponding story while preserving the narrative structure of the story by using a Semantic Aware-Cross Attention (SA-CA) layer.

The scene element integration unit 223 may provide the scene images of the target story to the user terminal 100.

As described above, the story visualization server according to the example embodiment of the present disclosure analyzes and visualizes the main scenes and characters of the story on the basis of the text generation model and the image generation model, thereby generating relatively high-quality images having relatively high semantic consistency and/or contextual consistency with the corresponding story while preserving the narrative structure of the corresponding story as it is.

Hereinafter, the components of the story module 210 will be described in more detail.

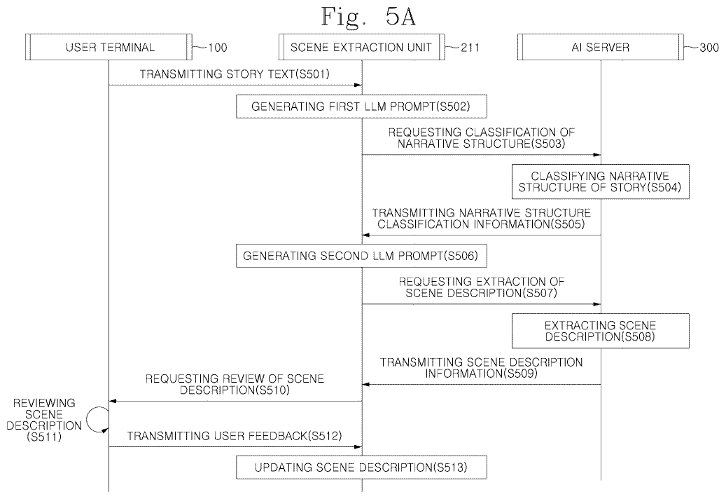

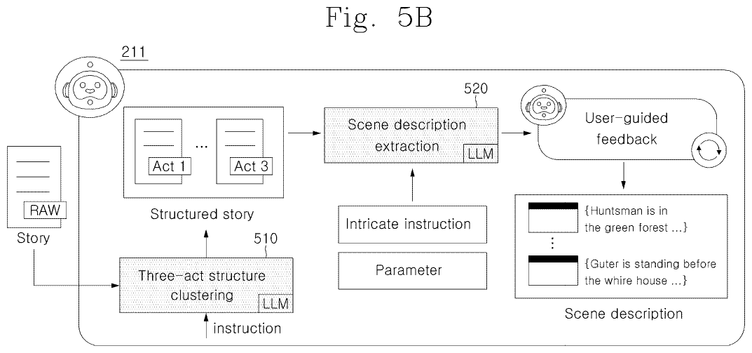

FIGS. 5A and 5B are views illustrating operations of a scene extraction unit according to an example embodiment of the present disclosure.

Referring to FIGS. 5A and 5B, in step S501, the scene extraction unit 211 according to an example embodiment of the present disclosure may obtain a target story from a user terminal 100.

The scene extraction unit 211 may generate a first LLM prompt including the target story and a first instruction. Here, the first instruction may be a command requesting classification of a narrative structure of the story.

In step S503, the scene extraction unit 211 may transmit the generated first LLM prompt to an AI server 300 and request classification of a narrative structure.

In step S504, the AI server 300 may classify the narrative structure of the story by inputting the first LLM prompt received from the scene extraction unit 211 into an LLM model. For example, as illustrated in FIG. 5B, a first LLM model 510 may analyze the narrative structure of the target story and classify the narrative structure of the corresponding story into three acts: setup (e.g., Act 1), confrontation (e.g., Act 2), and resolution (e.g., Act 3).

In step S505, the AI server 300 may provide information about the classified narrative structure to the scene extraction unit 211.

In step S506, the scene extraction unit 300 may generate a second LLM prompt including text information divided for each act of the narrative structure, desired (or alternatively, predefined) parameter information, and second instruction information. Here, the parameter information refers to information, which is to be extracted from the main scenes of the target story, (e.g., background information, foreground information, and/or the like). The second instruction information may be a command requesting extraction of descriptions of the main scenes of the target story.

In step S507, the scene extraction unit 211 may transmit the generated second LLM prompt to the AI server 300.

In step S508, the AI server 300 may extract description information about the main scenes of the target story by inputting the second LLM prompt received from the scene extraction unit 211 into an LLM model. For example, as illustrated in FIG. 5B, a second LLM model 520 may extract the description information about a plurality of scenes by identifying the main scenes for each act of the narrative structure of the target story. In this case, the description information about each scene may include information about the background, foregrounds, and interactions included in each main scene of the target story.

In step S509, the AI server 300 may transmit the scene description information of the target story to the scene extraction unit 211. The scene extraction unit 211 may store the scene description information received from the AI server 300 in a storage (not shown).

In step S510, the scene extraction unit 211 may transmit the scene description information of the target story to the user terminal 100. The user terminal 100 may display the scene description information received from the scene extraction unit 211 on a display unit. In step S511, the user may review the scene description information displayed on the user terminal 100 and modify the scene description information according to his or her review result.

In step S512, the scene extraction unit 211 may receive user feedback information about the scene description information from the user terminal 100 in a case where the user modifies the scene description information. In step S513, the scene extraction unit 211 may update the scene description information of the target story on the basis of the user feedback information received from the user terminal 100.

The scene extraction unit 211 may provide the updated scene description information to the prompt generation unit 213.

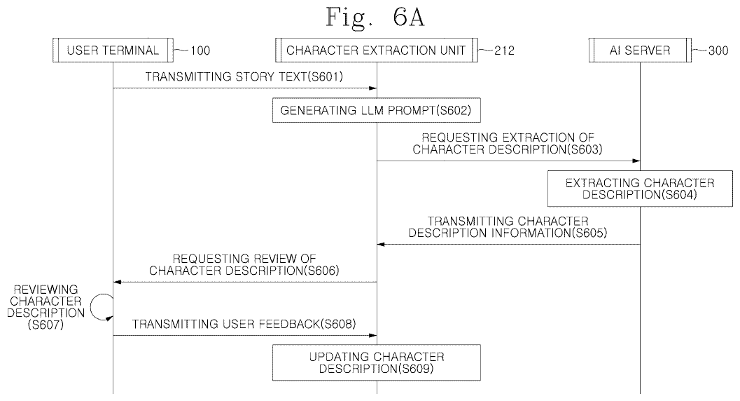

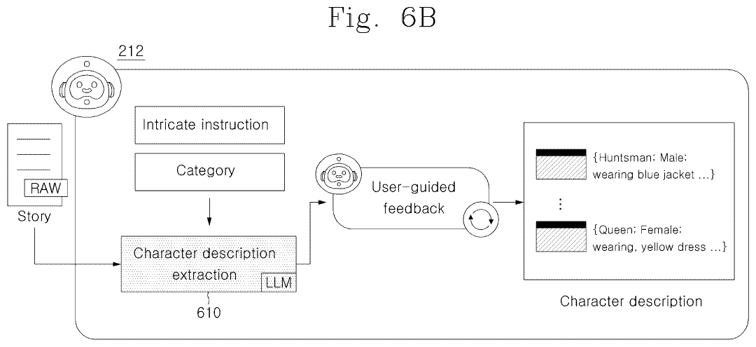

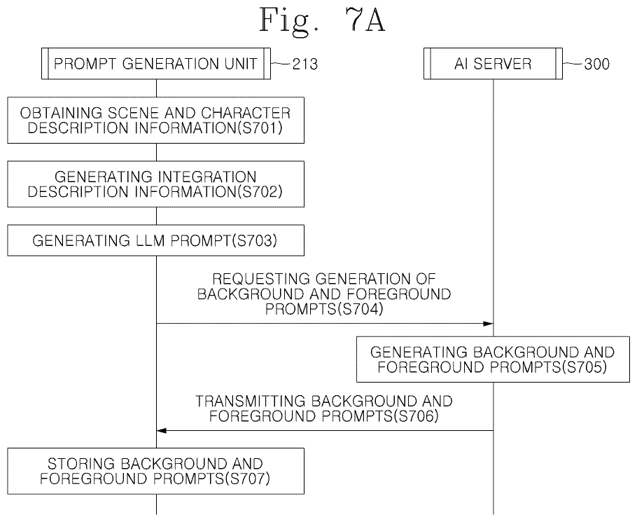

FIGS. 6A and 6B are views illustrating operations of a character extraction unit according to an example embodiment of the present disclosure.

Referring to FIGS. 6A and 6B, in step S601, the character extraction unit 212 according to an example embodiment of the present disclosure may obtain the target story from the user terminal 100.

In step S602, the character extraction unit 300 may generate an LLM prompt including the target story, desired (or alternatively, predefined) category information, and instruction information. Here, the category information refers to information representing features (e.g., gender, clothing, movement, location, and/or the like) of each character appearing in the target story. The instruction information may be a command requesting extraction of descriptions of key characters appearing in the story.

In step S603, the character extraction unit 212 may transmit the generated LLM prompt to the AI server 300 and request extraction of characters.

In step S604, the AI server 300 may input the LLM prompt received from the character extraction unit 212 into an LLM model and extract description information about characters appearing in the target story. For example, as illustrated in FIG. 6B, the LLM model 610 may extract the description information about a plurality of characters by identifying the features of key characters appearing in the target story. In this case, the description information for each character may include information about feature information and relationship information of each character included in the main scenes of the target story.

In step S605, the AI server 300 may transmit the character description information of the target story to the character extraction unit 212. The character extraction unit 212 may store the character description information received from the AI server 300 in the storage.

In step S606, the character extraction unit 211 may transmit the character description information of the target story to the user terminal 100. The user terminal 100 may display the character description information received from the character extraction unit 212 on the display unit. In step S607, the user may review the character description information displayed on the user terminal 100 and modify the character description information according to his or her review result.

In step S608, the character extraction unit 212 may receive user feedback information about the character description information from the user terminal 100 in a case where the user modifies the character description information. In step S609, the character extraction unit 212 may update the character description information of the target story on the basis of the user feedback information received from the user terminal 100.

The character extraction unit 212 may provide the updated character description information to the prompt generation unit 213.

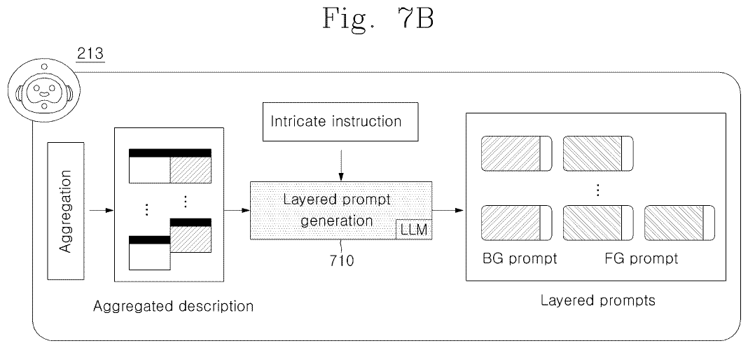

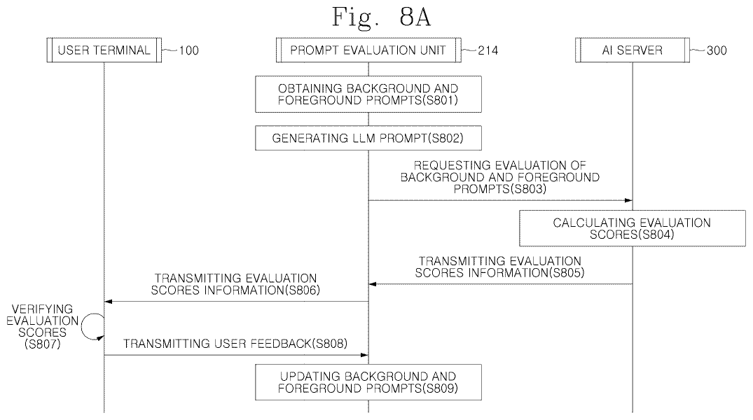

FIGS. 7A and 7B are views illustrating operations of a prompt generation unit according to the example embodiment of the present disclosure.

Referring to FIGS. 7A and 7B, in step S701, the prompt generation unit 213 according to an example embodiment of the present disclosure may obtain the scene description information of the target story from the scene extraction unit 211 and obtain the character description information of the target story from the character extraction unit 212.

In step S702, the prompt generation unit 213 may generate integrated or combined description information by aggregating the obtained scene description information and character description information. In this case, the integration description information may be generated for each main scene of the target story.

In step S703, the prompt generation unit 213 may generate an LLM prompt including the integrated description information and instruction information. Here, the instruction information may be a command requesting generation of a background prompt and foreground prompts, which are desired for image generation.

In step S704, the prompt generation unit 213 may transmit the generated LLM prompt to the AI server 300, and request generation of background and foreground prompts.

In step S705, the AI server 300 may generate the background and foreground prompts for the main scenes of the target story by inputting the LLM prompt received from the prompt generation unit 213 into an LLM model. In this case, the background and foreground prompts may be text data. In addition, the foreground prompts may be generated as many times as the number of characters included in a corresponding scene.

For example, as illustrated in FIG. 7B, the LLM model 710 may identify the background and foregrounds for each of the main scenes of the target story and generate the background prompt and the foreground prompts. For example, a background prompt for a particular scene might be “A towering, fantastical beanstalk spiraling up into the clouds,” and a foreground prompt for the corresponding scene might be “A young boy in green medieval clothing climbing the beanstalk.”.

In step S706, the AI server 300 may transmit prompt information for each main scene of the target story to the prompt generation unit 213. In step S707, the prompt generation unit 213 may store the prompt information received from the AI server 300 in the storage.

The prompt generation unit 213 may provide the prompt information for each main scene of the target story to the prompt evaluation unit 214.

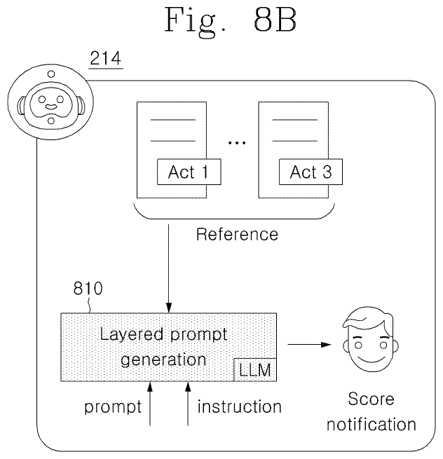

FIGS. 8A and 8B are views illustrating operations of a prompt evaluation unit according to an example embodiment of the present disclosure.

Referring to FIGS. 8A and 8B, in step S801, the prompt evaluation unit 214 according to an example embodiment of the present disclosure may obtain the prompt information for each main scene of the target story from the prompt generation unit 213.

In step S802, the prompt evaluation unit 214 may generate an LLM prompt that includes the text information for each act of the narrative structure of the target story, the prompt information for each main scene of the target story, and the instruction information. Here, the instruction information may be a command requesting generation of evaluation scores of the prompts for each main scene of the target story.

In step S803, the prompt evaluation unit 214 may transmit the generated LLM prompt to the AI server 300 and request evaluation of background and foreground prompts.

In step S804, the AI server 300 may calculate the evaluation scores of the prompts for each main scene of the target story by inputting the LLM prompt received from the prompt evaluation unit 214 into an LLM model. For example, as illustrated in FIG. 8B, the LLM model 810 may calculate the evaluation scores by measuring degrees of similarity between the prompts for each main scene of the story and the content of original text of the corresponding story. This is for quantitatively checking the extent to which the prompts for each main scene of the story include content that matches the original text of the corresponding story.

In step S805, the AI server 300 may transmit information about the calculated evaluation scores to the prompt evaluation unit 214. The prompt evaluation unit 214 may store the evaluation score information received from the AI server 300 in the storage.

In step S806, the prompt evaluation unit 214 may transmit the evaluation scores for the prompts for each main scene of the target story to the user terminal 100. The user terminal 100 may display the evaluation score information received from the prompt evaluation unit 214 on the display unit. In step S807, the user may review the evaluation score information displayed on the user terminal 100 and modify the prompt information according to his or her review result.

In step S808, the prompt evaluation unit 214 may receive user feedback information for a corresponding prompt from the user terminal 100 in a case where the user modifies the specific prompt. In step S809, the prompt evaluation unit 214 may update the corresponding prompt information on the basis of the user feedback information received from the user terminal 100. Meanwhile, according to some example embodiments of the present disclosure, a process of updating a prompt on the basis of user feedback information may be omitted.

The prompt evaluation unit 214 may provide the updated prompt information to the image module 220.

Hereinafter, the components of the image module 220 will be described in more detail.

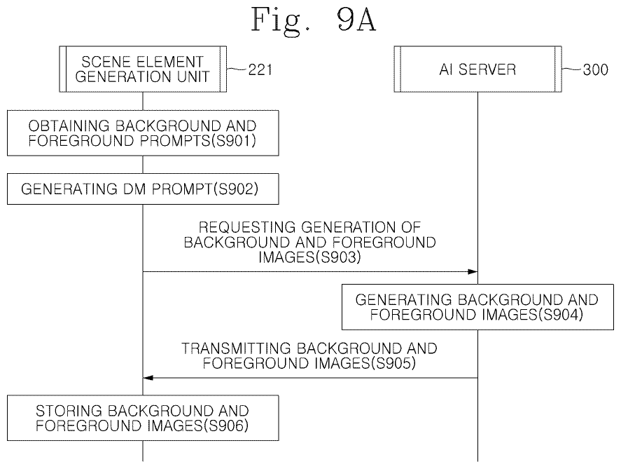

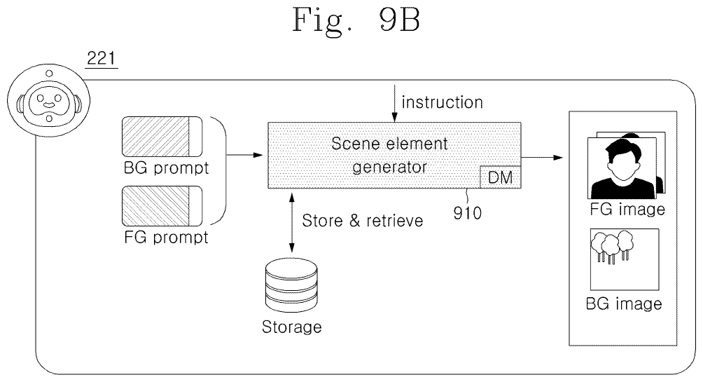

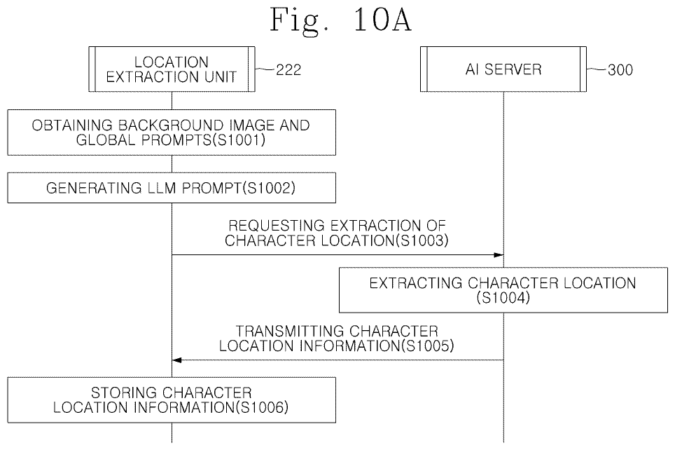

FIGS. 9A and 9B are views illustrating operations of a scene element generation unit according to the example embodiment of the present disclosure.

Referring to FIGS. 9A and 9B, in step S901, the scene element generation unit 221 according to an example embodiment of the present disclosure may obtain background and foreground prompts for the main scenes of the target story from the story module 210.

In step S902, the scene element generation unit 221 may generate a direct message (DM) prompt including background and foreground prompt information for the main scenes of the target story, reference image information, and instruction information. Here, the instruction information may be a command requesting generation of a background image and foreground images. The reference image information is scene images generated previously on the basis of a current point in time, and may be used to generate a scene image of the next point in time. The reference image information may be omitted according to some example embodiments of the present disclosure.

In step S903, the scene element generation unit 221 may transmit the generated DM prompt to the AI server 300 and request extraction of background and fore ground images.

In step S904, the AI server 300 may generate background images and foreground images for the main scenes of the target story by inputting the DM prompt received from the scene element generation unit 221 into a diffusion model. For example, as illustrated in FIG. 9B, the diffusion model 910 may generate a background image on the basis of an input background prompt. In addition, the diffusion model 910 may generate one or more foreground images on the basis of one or more input foreground prompts.

In step S905, the AI server 300 may transmit the background and foreground images for the main scenes of the target story to the scene element generation unit 221. In step S906, the scene element generation unit 221 may store the background and foreground images received from the AI server 300 in the storage.

The scene element generation unit 221 may provide the generated background and foreground images to the location extraction unit 222 and the scene element integration unit 223.

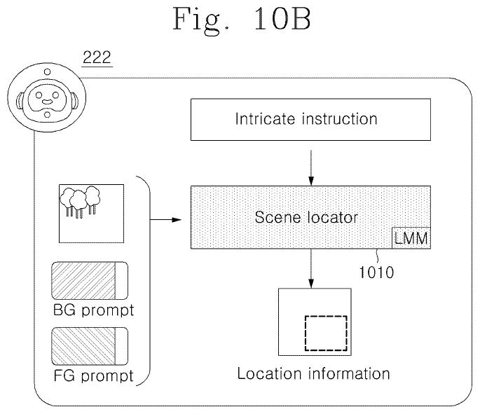

FIGS. 10A and 10B are views illustrating operations of a location extraction unit according to an example embodiment of the present disclosure.

Referring to FIGS. 10A and 10B, in step S1001, the location extraction unit 222 according to an example embodiment of the present disclosure may obtain the background images for the main scenes of the target story from the scene element generation unit 221. In addition, the location extraction unit 222 may obtain global prompts for the main scenes of the target story from the story module 210. Here, the global prompts may include one background prompt and one or more foreground prompts.

In step S1002, the location extraction unit 222 may generate an LLM prompt including background image information, global prompt information, and instruction information. Here, the instruction information may be a command requesting location information of a character included in each main scene of the target story. Meanwhile, in another example embodiment, an LLM prompt may further include foreground image information.

In step S1003, the location extraction unit 222 may transmit the generated LLM prompt to the AI server 300 and request extraction of a character location.

In step S1004, the AI server 300 may extract location information of the character included in each of the main scenes of the target story by inputting an LLM prompt received from the location extraction unit 222 into an LLM model. For example, as illustrated in FIG. 10B, the LLM model 1010 may detect where the character exists on a background image by analyzing semantic relationships between a background element and foreground elements of each scene.

In step S1005, the AI server 300 may transmit the extracted character location information to the location extraction unit 222. The location extraction unit 222 may store the character location information received from the AI server 300 in the storage. The location extraction unit 222 may provide the character location information for the main scenes of the target story to the scene element integration unit 223.

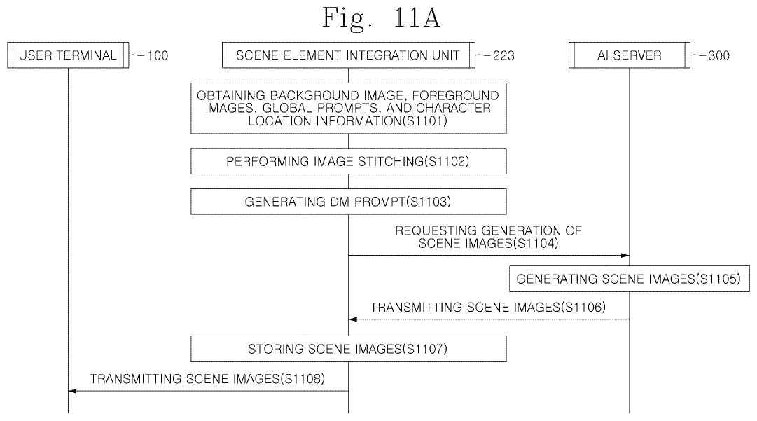

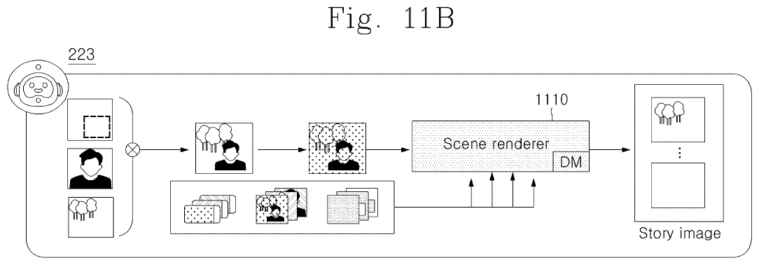

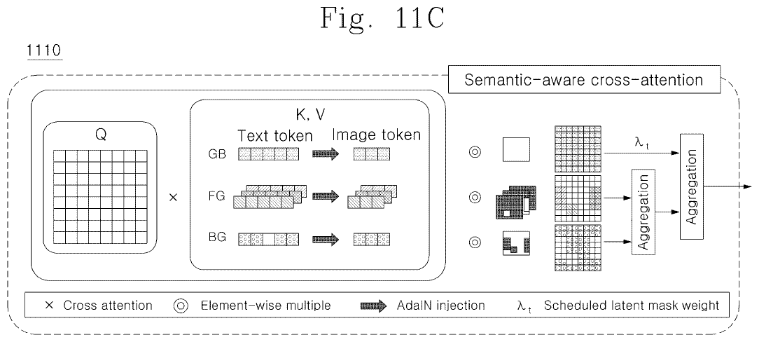

FIGS. 11A to 11C are views illustrating operations of a scene element integration unit according to an example embodiment of the present disclosure.

Referring to FIGS. 11A to 11C, in step S1101, the scene element integration unit 223 according to an example embodiment of the present disclosure may obtain the global prompts for the main scenes of the target story from the story module 210.

The scene element integration unit 223 may obtain the background images and foreground images for the main scenes of the target story from the scene element generation unit 221. In addition, the scene element integration unit 223 may obtain the character location information for the main scenes of the target story from the location extraction unit 222.

In step S1102, the scene element integration unit 223 may generate a stitched image by combining the background and foreground images for each layer on the basis of the location information of the character included in each scene. In this case, the stitched image may be generated for each main scene of the target story. In addition, the stitched image may be used as an image to be a target of noise removal.

In step S1103, the scene element integration unit 223 may generate a DM prompt including stitched images, diffusion condition information, and instruction information for the main scenes of the target story. Here, the diffusion condition information may include at least one of the background images, foreground images, global prompts, or character location information. The instruction information may be a command requesting generation of relatively high-quality scene images based on the stitched images.

In step S1104, the scene element integration unit 223 may transmit the generated DM prompt to the AI server 300 and request generation of scene images.

In step S1105, the AI server 300 may generate final images for the main scenes of the target story by inputting the DM prompt received from the scene element integration unit 223 into the diffusion model.

For example, as illustrated in FIG. 11B, the diffusion model 1110 may generate the relatively high-quality scene images by sequentially removing noise included in the input stitched images while referring to the input diffusion condition information. In addition, as illustrated in FIG. 11C, the diffusion model 1110 may generate scene images having relatively high semantic consistency and/or contextual consistency with the target story while preserving the narrative structure of the target story by using an SA-CA layer. For example, in a case where a feature vector of a stitched image is set as a query vector and a feature vector of the diffusion condition information is set as a key vector and a value vector, the diffusion model 1110 may perform cross attention between the feature vector of the stitched image and the feature vector of the diffusion condition information. In addition, the diffusion model 1110 may maintain relatively high semantic consistency between a text token and an image token by using an adaptive instance normalization (AdaIN) layer.

In step S1106, the AI server 300 may transmit the generated scene images to the scene element integration unit 223. In step S1107, the scene element integration unit 223 may store the scene images received from the AI server 300 in the storage. The scene element integration unit 223 may provide the scene images for the target story to the user terminal 100.

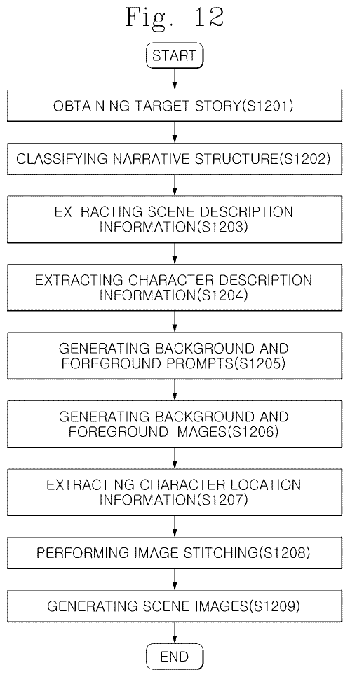

FIG. 12 is a flowchart illustrating a story visualization method according to an example embodiment of the present disclosure. The story visualization method according to an example embodiment of the present example embodiment may be performed by the story visualization server 200. Although the story visualization method is described in the plurality of steps in the illustrated flowcharts, at least some of the steps may be performed in a changed order, may be combined with other steps and performed together, may be omitted, may be divided into substeps and performed, or may be performed with one or more additional steps not illustrated.

Referring to FIG. 12, in step S1201, the story visualization server 200 according to an example embodiment of the present disclosure may obtain a target story from a user terminal 100.

In step S1202, the story visualization server 200 may classify a narrative structure of the target story on the basis of the obtained target story by using an LLM model.

In step S1203, the story visualization server 200 may extract scene description information for each main scene of the target story on the basis of text information classified for each act of the narrative structure of the target story by using an LLM model. In this case, the scene description information may include background information, foreground information, and interaction information, which are included in each main scene of the target story.

In step S1204, the story visualization server 200 may extract character description information for each main scene of the target story on the basis of the obtained target story by using an LLM model. In this case, the character description information may include feature information, relationship information, and/or the like of a character included in each main scene of the target story.

The story visualization server 200 may generate integrated description information by combining the scene description information and the character description information for each main scene of the target story. In step S1205, the story visualization server 200 may generate background prompts and foreground prompts for the main scenes of the target story on the basis of the generated integrated description information by using an LLM model.

In step S1206, the story visualization server 200 may generate background images and foreground images for the main scenes of the target story on the basis of the background prompts and foreground prompts for the main scenes of the target story by using a diffusion model.

In step S1207, the story visualization server 200 may extract character location information for the main scenes of the target story on the basis of the background images and global prompts for the main scenes of the target story by using an LLM model.

In step S1208, the story visualization server 200 may generate stitched images for the main scenes of the target story by stitching the background images and foreground images on the basis of the extracted character location information. Here, image stitching refers to a technique of combining multiple images into one image.

In step S1209, the story visualization server 200 may generate final images for the main scenes of the target story on the basis of the stitched images and diffusion condition information for the main scenes of the target story by using a diffusion model. In this case, the diffusion model may generate the final images having relatively high semantic consistency and/or contextual consistency with the target story while preserving the narrative structure of the target story by using an SA-CA layer.

The story visualization server 200 may store the final images of the main scenes of the target story in a storage. The story visualization server 200 may provide the final images of the main scenes of the target story to the user terminal 100.

As described above, the story visualization method according to the above-described example embodiments of the present disclosure analyzes and visualizes the main scenes and characters of the story on the basis of the text generation model and the image generation model, thereby generating the relatively high-quality images having relatively high semantic consistency and/or contextual consistency with the corresponding story while preserving the narrative structure of the corresponding story as it is.

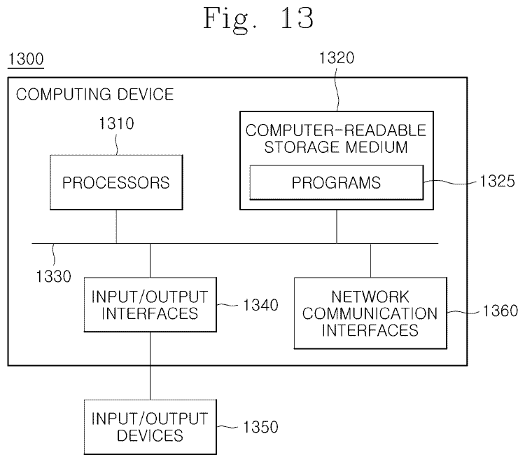

FIG. 13 is a block diagram illustrating a computing device according to an example embodiment of the present disclosure.

Referring to FIG. 13, a computing device 1300 according to an example embodiment of the present disclosure may include at least one processor 1310, a computer-readable storage medium 1320, and a communication bus 1330. The computing device 1300 may implement the above-described story visualization server 200 or may implement the components 211 to 223 constituting the story visualization server 200. In addition, the computing device 1300 may implement the user terminal 100 or AI server 300 described above.

Each processor 1310 may cause the computing device 1300 to operate according to the example embodiment described above. For example, each processor 1310 may execute one or more programs 1325 stored in the computer-readable storage medium 1320. The one or more programs may include one or more computer-executable instructions. In a case of being executed by each processor 1310, the computer-executable instructions may be configured to cause the computing device 1300 to perform operations according to the example embodiment described above.

The computer-readable storage medium 1320 is configured to store computer-executable instructions or program codes, program data, and/or other suitable forms of information. Each program 1325 stored in the computer-readable storage medium 1320 includes a set of instructions executable by each processor 1310. In the example embodiment, the computer-readable storage medium 1320 may be memories (e.g., a volatile memory such as a random access memory, a non-volatile memory, or a suitable combination thereof), one or more magnetic disk storage devices, optical disk storage devices, flash memory devices, any other forms of storage media accessible by the computing device 1300 and configured to store desired information, or a suitable combination thereof.

The communication bus 1330 interconnects various other components of the computing device 1300, including each processor 1310 and the computer-readable storage medium 1320.

The computing device 1300 may also include one or more input/output interfaces 1340 for providing interfaces for one or more input/output devices 1350 and one or more network communication interfaces 1360. The input/output interfaces 1340 and the network communication interfaces 1360 are connected to the communication bus 1330.

The input/output devices 1350 may be connected to other components of the computing device 1300 through the input/output interfaces 1340. The example input/output devices 1350 may include input devices such as pointing devices (e.g., a mouse or a trackpad), keyboards, touch input devices (e.g., a touchpad or a touchscreen), voice or sound input devices, various types of sensor devices, and/or photographing devices, and/or output devices such as display devices, printers, speakers, and/or network cards. The example input/output devices 1350 may be included within the computing device 1300 as components constituting the computing device 1300, or may be connected, as separate devices distinguished from the computing device 1300, to the computing device 1300.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The story visualization server according to some example embodiments of the present disclosure may be implemented by at least one computing device 1300, and the story visualization method according to some example embodiments of the present disclosure may be performed by the at least one computing device included in the story visualization server. In this case, the computer program according to some example embodiments of the present disclosure may be installed and operated on the computing device, and the computing device may perform the story visualization method according to the example embodiments of the present disclosure under the control of the computer program in operation. The computer program described above may be stored in the computer-readable recording medium combined with the computing device and configured to execute the story visualization method on a computer.

The above-described example embodiment of the present disclosure may be implemented as computer-readable code in the medium on which the program is recorded. The computer-readable medium may also be a medium that keeps storing the computer-executable program or may be a medium that temporarily stores the program for the purpose of execution or downloading. In addition, the medium may be one of various recording means or storage means in the form of a single hardware component or a combination of multiple hardware components, and is not limited to a medium directly connected to a certain computer system, but may also be one of media distributed over a network. As an example, the medium includes a magnetic medium such as a hard disk, a floppy disk, and a magnetic tape, an optical recording medium such as CD-ROM and DVD, a magneto-optical medium such as a floptical disk, and a medium including ROM, RAM, and/or a flash memory and for storing program instructions. In addition, as another example, the medium may also include an app store that distributes applications, a website that supplies or distributes various software, and/or a recording medium or storage medium that is managed by a server, etc. Accordingly, the above detailed description should not be construed as restrictive in all respects but is intended only as an example. The scope of the present disclosure should be determined by a reasonable interpretation of the appended claims, and all modifications within the equivalent scope of the present disclosure are included in the scope of the present disclosure.

The effectiveness of the story visualization methods and the story visualization devices thereof according to the above-described example embodiments of the present disclosure are described as follows.

According to at least one of the above-described example embodiments of the present disclosure, because the main scenes and characters of the story are analyzed and visualized on the basis of the text generation model and the image generation model, relatively high-quality images that have relatively high semantic consistency and/or contextual consistency with the corresponding story may be generated while preserving the narrative structure of the corresponding story as it is.

However, the effectiveness that may be achieved by the story visualization methods and the story visualization devices thereof according to example embodiments of the present disclosure are not limited to those mentioned above, and other effectiveness that is not mentioned may be clearly understood by those skilled in the art to which the present disclosure belongs from the descriptions below.

The present disclosure is not limited to the above-described example embodiment and the attached drawings. It will be apparent to those skilled in the art that the components according to the above-described example embodiments of the present disclosure may be substituted, modified, and changed without departing from the technical spirit of the present disclosure.

What is claimed is:

1. A story visualization method comprising:
obtaining a story;
extracting scene description information and character description information by analyzing the story;
generating prompts for each of main scenes of the story based on the scene description information and the character description information;
generating a background image and foreground images based on the prompts for each of the main scenes of the story; and
generating story images for the main scenes of the story by integrating the background image and the foreground images.

2. The story visualization method of claim 1, wherein the extracting extracts the scene description information by:
classifying a narrative structure of the story using a first Large Language Model (LLM) model; and
identifying the main scenes for each classified act of the narrative structure and extracting the scene description information for each of the identified main scene, using a second LLM model.

3. The story visualization method of claim 1, wherein the scene description information comprises background information and foreground information that are included in each of the main scenes of the story.

4. The story visualization method of claim 1, wherein the extracting extract the character description information by extracting the character description information for each of the main scenes of the story using a first LLM model.

5. The story visualization method of claim 1, wherein the character description information comprises feature information and relationship information of a character that are included in each of the main scenes of the story.

6. The story visualization method of claim 1, further comprising:
providing the scene description information and the character description information to a user terminal; and
updating the scene description information and the character description information based on user feedback information received from the user terminal.

7. The story visualization method of claim 1, wherein the generating prompts further comprises:
generating integration description information by combining the scene description information and the character description information; and
generating the prompts for each of the main scenes of the story based on the integrated description information using a first LLM model.

8. The story visualization method of claim 1, further comprising:
calculating evaluation scores for the prompts using a first LLM model; and
providing the evaluation scores to a user terminal.

9. The story visualization method of claim 1, wherein the prompts comprise one background prompt and one or more foreground prompts.

10. The story visualization method of claim 9, wherein the generating a background image and foreground images comprises:
generating the background image based on the background prompt using a first diffusion model; and
generating the foreground images based on the foreground prompts using the first diffusion model.

11. The story visualization method of claim 1, further comprising:
extracting character location information of the main scenes of the story based on the background image and the prompts using a first LLM model.

12. The story visualization method of claim 11, wherein the generating the story images comprises:
generating stitched images by combining the background image and the foreground images based on the character location information; and
generating the story images based on the stitched images and diffusion condition information using a second diffusion model.

13. The story visualization method of claim 12, wherein the diffusion condition information comprises at least one of the background image, the foreground images, the prompts, or the character location information.

14. The story visualization method of claim 12, wherein the second diffusion model generates the story images by using a Semantic Aware-Cross Attention (SA-CA) layer.

15. The story visualization method of claim 1, further comprising:
providing the story images to a user terminal.

16. A story visualization server comprising:
one or more processors configured to execute a plurality of instructions to cause the story visualization server to perform a plurality of operations; and
one or more memories configured to store the plurality of instructions,
wherein the plurality of operations comprises
obtaining a story,
extracting scene description information and character description information by analyzing the story,
generating prompts for each of main scenes of the story based on the extracted scene description information and the character description information,
generating a background image and foreground images based on the prompts for each of the main scenes of the story, and
generating story images for the main scenes of the story by integrating the background image and the foreground images.

17. The server of claim 16, wherein
the scene description information comprises background information and foreground information that are included in each of the main scenes of the story, and
the character description information comprises feature information and relationship information of a character that are included in each of the main scenes of the story.

18. The story visualization server of claim 16, wherein the plurality of operations further comprises:
calculating evaluation scores for the prompts using a Large Language Model (LLM) model; and
providing the evaluation scores to a user terminal.

19. The story visualization server of claim 16, wherein the plurality of operations further comprises:
extracting character location information of the main scenes of the story based on the background image and the prompts using an LLM model.

20. A non-transitory computer-readable storage medium storing instructions thereon, which when executed by at least one processor, cause a computer system to implement a story visualization method, the method comprising:
obtaining a story;
extracting scene description information and character description information by analyzing the story;
generating prompts for each of main scenes of the story based on the scene description information and the character description information;
generating a background image and foreground images based on the prompts for each of the main scenes of the story; and
generating story images for the main scenes of the story by integrating the background image and the foreground images.
